(19) United States
(12) Patent Application Publication
(10) Pub. No.: US 2005/0114247 A1
(43) Pub. Date: May 26, 2005

(54) A Method to Forecast Returns on Stocks, Bonds, Bills, and Inflation Using Corporate Bond Forward Rates

(75) Inventor: Charles Robert Kenley, RICHMOND, IN (US)

Correspondence Address: KENLEY CONSULTING, LLC, 165 S. 20TH ST, RICHMOND, IN, 47374-5723, US

(73) Assignee: KENLEY CONSULTING, LLC, RICHMOND, IN (US)

(21) Appl. No.: 10/707,114

(22) Filed: Nov. 21, 2003

(51) Int. Cl. G06F 17/60

(52) U.S. Cl. 705/36; 705/35

(57) ABSTRACT

This invention modifies the Ibbotson-Sinquefield model to use current corporate bond yields as the principal input for forecasting returns on stocks, bonds, treasury bills, and inflation rates. This allows increasing the forecast period to the maximum time horizon using corporate bond yields, which currently is up to 100 years.

### FEDERAL RESEARCH STATEMENT

This invention was made with Department of Energy support under Subcontract No. PA002730 awarded by Bechtel SAIC Company, LLC under DOE contract no. DE-AC28-01RW-12101. Kenley Consulting, LLC has certain rights in this invention as a small business under 35 USC 202. The Department of Energy also has certain rights in this invention under 35 USC 202.

### COPYRIGHT STATEMENT

Copyright © 2003, Kenley Consulting, LLC, 165 S 20th, Richmond, Ind., 47374-5723, USA

### BACKGROUND OF INVENTION

This invention relates to the field of macroeconomic forecasting.

The Ibbotson-Sinquefield (1976b) model currently is limited to a 25-year time horizon for forecasting returns on stocks, bonds, treasury bills, and inflation rates. It eventually will be limited to 10 years. The government bond forward rates that must be used for the Ibbotson-Sinquefield forecast limit the maximum time horizon of the forecast. Previously, forward rates up to 30 years were available until the discontinuance of the U.S. Treasury 30-year constant maturity government bond series on Feb. 18, 2002. In 2022, this will result in reducing the forward rate maximum time horizon to 10 years, which currently is the longest term U.S. Treasury debt instrument available.

The Ibbotson-Sinquefield (1976b) model uses annual historical returns for common stocks, long-term U.S. government and corporate bonds, U.S. Treasury bills, and inflation for the period 1926-74 that were first presented by them in an earlier paper (Ibbotson and Sinquefield, 1976a). The model also employed what was then the current U.S. government bond yield curve in 1976. Combining clarifications from Lewis, et al (1980) with the original description from Ibbotson and Sinquefield, the Ibbotson-Sinquefield equations for forecasting returns based on historical data are:
\overline{R}r(t)=−0.0015+0.623 \overline{R}r(t−1) Eqn. (1)

$$E qn . ( 2 ) Fg ( t ) = \frac{{( 1 + Yg ( t ) )}^{t}}{{( 1 + Yg ( t - 1 ) )}^{t - 1}} - 1$$

\overline{R}i(t)=Fg(t)−\overline{R}1−\overline{R}r(t) Eqn. (3)
\hat{R}r(t)=\overline{R}r(t)+êr(t) Eqn. (4)
\hat{R}i(t)=\overline{R}i(t)+êi(t) Eqn. (5)
\hat{R}f(t)=\hat{R}r(t)+\hat{R}i(t) Eqn. (6)
\hat{R}m(t)=\hat{R}f(t)+\hat{R}p(t) Eqn. (7)
\hat{R}g(t)=\hat{R}f(t)+\hat{R}l(t) Eqn. (8)
\hat{R}c(t)=\hat{R}g(t)+\hat{R}d(t) Eqn. (9)
\hat{R}mr(t)=\hat{R}r(t)+\hat{R}p(t) Eqn. (10)
\hat{R}gr(t)=\hat{R}r(t)+\hat{R}l(t) Eqn. (11)
\hat{R}cr(t)=\hat{R}gr(t)+\hat{R}d(t) Eqn. (12)

The terms in Eqn. (1) through Eqn. (12) are defined as follows:
\hat{R}r(t) real treasury bill return forecast for year t
êr(t)=noise term for real treasury bill return forecast for year t
Yg(t)=market-based government bond yield for bond maturing at year t
Fg(t)=government bond forward rate at year t
\overline{R}1=historical average maturity premium
\overline{R}r(t)=real treasury bill return mean value for year t
\hat{R}i(t)=inflation forecast for year t
\overline{R}i(t)=inflation mean value for year t
êi(t)=noise term for inflation forecast for year t
\hat{R}f(t)=treasury bill return forecast for year t
\hat{R}m(t)=common stock return forecast for year t
\hat{R}p(t)=risk premium forecast for year t
\hat{R}g(t)=U.S. government bonds return forecast for year t
\hat{R}1(t)=maturity premium forecast for year t
\hat{R}c(t)=corporate bond return forecast for year t
\hat{R}d(t)=default premium forecast for year t
\hat{R}mr(t)=real common stock return forecast for year t
\hat{R}gr(t)=real U.S. government bonds return forecast for year t
\hat{R}cr(t)=real corporate bond return forecast for year t

Eqn. (2) and Eqn. (3) use the government bond yields to develop a forecast. In 1976, Ibbotson and Sinquefield had available market data on yields to maturity for government bonds for 1 to 25 years into the future. This is because at that time there were 30-year government bonds actively traded on the market. Any forecast based on these yields could not extend beyond 25 years. As of Feb. 18, 2002, the U.S. government no longer issues 30-year bonds. The longest term for an instrument offered by the U.S. government is 10 years for a treasury note. Using 10-year treasury notes would reduce the forecast period to 10 years or less.

The use of long-term debt instrument yields is the key to capturing the market consensus of future inflation in that a long-term yield is of a series of anticipated short-term interest rates plus inflation. U.S. government debt instruments are no longer available to establish inflation and interest expectations beyond 10 years. There needs to be an alternative debt instrument to extend the forecast period basis. Corporate bonds are one source to extend the forecast period. Bonds with maturity dates 100 years into the future have been issued by Coca Cola, Walt Disney, and Citigroup. It is necessary to replace Eqn. (2) and Eqn. (3) to use corporate bond yields to extend the forecast period.

### SUMMARY OF INVENTION

This invention modifieo the Ibbotson-Sinquefield model to use current corporate bond yields as the principal input for forecasting returns on stocks, bonds, treasury bills, and inflation rates. This allows increasing the forecast period to the maximum time horizon using corporate bond yields, which currently is up to 100 years.

### DETAILED DESCRIPTION

The new forecasting equations for this invention are as follows:
\overline{R}r(t)=α+β\overline{R}r(t−1) Eqn (13)

$$Eqn . ( 14 ) F c ( t ) = \frac{{( 1 + Yc ( t ) )}^{t}}{{( 1 + Yc ( t - 1 ) )}^{t - 1}} - 1$$

\overline{R}i(t)=Fc(t)−\overline{R}d−\overline{R}1−\overline{R}r(t) Eqn (15)
\hat{R}r(t)=\overline{R}r(t)+\overline{e}r(t) Eqn (16)
\hat{R}i(t)=\overline{R}i(t)+êi(t) Eqn (17)
\hat{R}f(t)=\hat{R}r(t)+\hat{R}i(t) Eqn (18)
\hat{R}m(t)=\hat{R}f(t)+\hat{R}p(t) Eqn (19)
\hat{R}g(t)=\hat{R}f(t)+\hat{R}l(t) Eqn (20)
\hat{R}c(t)=\hat{R}g(t)+\hat{R}d(t) Eqn (21)
\hat{R}mr(t)=\hat{R}r(t)+\hat{R}p(t) Eqn (22)
\hat{R}gr(t)=\hat{R}r(t)+\hat{R}l(t) Eqn (23)
\hat{R}cr(t)=\hat{R}gr(t)+\hat{R}d(t) Eqn (24)

Eqn. (13) replaces the coefficients in Eqn. (1) with parameters to allow them to vary as more historical data becomes available. Eqn. (14) and Eqn. (15) replace Eqn. (2) and Eqn. (3) entirely. Eqn. (16) through Eqn. (24) are identical to Eqn. (4) thorough Eqn. (12). The terms in Eqn. (13) through Eqn. (24) are defined as follows:
\hat{R}r(t)=real treasury bill return forecast for year t
α=intercept coefficient for autoregression fit of historical values of real treasury bill returns
β=slope coefficient for autoregression fit of historical values of real treasury bill returns
\hat{R}r(t)=noise term for real treasury bill return forecast for year t
Yc(t)=market-based corporate bond yield for bond maturing at year t
Fc(t)=corporate bond forward rate at year t
\overline{R}d=historical average default premium
\overline{R}1=historical average maturity premium
\overline{R}r(t)=real treasury bill return mean value for year t
\hat{R}i(t)=inflation forecast for year t
\overline{R}i(t)=inflation mean value for year t
êi(t)=noise term for inflation forecast for year t
\hat{R}f(t)=treasury bill return forecast for year t
\hat{R}m(t)=common stock return forecast for year t
\hat{R}p(t)=risk premium forecast for year t
\hat{R}g(t)=U.S. government bonds return forecast for year t
\hat{R}l(t)=maturity premium forecast for year t
\hat{R}c(t)=corporate bond return forecast for year t
\hat{R}d(t)=default premium forecast for year t
\hat{R}mr(t)=real common stock return forecast for year t
\hat{R}gr(t)=real U.S. government bonds return forecast for year t
\hat{R}cr(t)=real corporate bond return forecast for year t

### REFERENCES

Ibbotson, Roger G. and Rex A. Sinquefield (1976a), “Stocks, Bonds, Bills, and Inflation: Year-by-Year Historical Returns (1926-1974)”, The Journal of Business, Volume 49, Issue 1, January 1976, pp 11-47.

Ibbotson, Roger G. and Rex A. Sinquefield (1976b), “Stocks, Bonds, Bills, and Inflation: Simulations of the Future (1976-2000)”, The Journal of Business, Volume 49, Issue 3,July 1976, pp 313-338.

Lewis, Alan L., Sheen T. Kassouf, R. Dennis Brehm, and Jack Johnston, “The Ibbotson-Sinquefield Simulation Made Easy”, The Journal of Business, Volume 53, Issue 2, April 1980, pp. 205-214.

1. A method that forecasts returns on stocks, bonds, treasury bills, and inflation rates using current corporate bond yields.

2. A method according to claim 1, that forecasts the inflation mean value for year t by applying Eqn. (15) that uses as input the following values:
the corporate bond forward rate at year t derived from corporate bond yields by applying Eqn. (14),
the historical average default premium,
the historical average maturity premium, and
the real treasury bill return mean value for year t.
